(19) United States
(12) Patent Application Publication
(10) Pub. No.: US 2025/0174055 A1
(43) Pub. Date: May 29, 2025

(54) DRIVING EVALUATION SYSTEM

(71) Applicant: TOYOTA JIDOSHA KABUSHIKI KAISHA, Toyota-shi (JP)

(72) Inventors: Takahiro Kamogawa, Nagoya-shi (JP); Masato Endo, Nagoya-shi (JP)

(73) Assignee: TOYOTA JIDOSHA KABUSHIKI KAISHA, Toyota-shi (JP)

(21) Appl. No.: 18/801,921

(22) Filed: Aug. 13, 2024

(30) Foreign Application Priority Data
Nov. 29, 2023 (JP) 2023-201330

(51) Int. Cl. G07C 5/02; G08G 1/052

(52) U.S. Cl. CPC G07C 5/02; G08G 1/052

(57) ABSTRACT

The communication device acquires, from the vehicle, vehicle speed information indicating the vehicle speed and position information indicating the position of the vehicle. The determining unit determines whether or not the vehicle is approaching the intersection with the stop sign based on the position information. When the determining unit determines that the vehicle is approaching the intersection with the stop sign, the evaluation unit evaluates the driving behavior of the driver of the vehicle based on the length of time that the vehicle has stopped at the intersection with the stop sign or the speed at which the vehicle passes through the intersection with the stop sign.

### CROSS-REFERENCE TO RELATED APPLICATION

This application claims priority to Japanese Patent Application No. 2023-201330 filed on Nov. 29, 2023, incorporated herein by reference in its entirety.

### BACKGROUND

### 1. Technical Field

The present disclosure relates to a system for evaluating driving behavior of a driver of a vehicle.

### 2. Description of Related Art

There is technology that is known for evaluating driving behavior of a driver of a vehicle in accordance with whether the vehicle comes to a stop at an intersection with a stop sign.

Japanese Unexamined Patent Application Publication No. 2009-217615 (JP 2009-217615 A) describes a driving evaluation device for evaluating stopping behavior of a driver at an intersection with a stop sign. The driving evaluation device initially diagnoses the stopping behavior of the driver based on detection values from a vehicle speed sensor when the own vehicle travels through an intersection with a stop sign. Subsequently, this driving evaluation device detects the presence or absence of intersecting traffic on an intersecting road that intersects a traveling road on which the own vehicle is traveling, and the presence or absence of a preceding vehicle traveling ahead of the own vehicle, based on detection values from a forward radar sensor. Also, this driving evaluation device determines a direction of travel of the own vehicle based on output of an automotive navigation system. This driving evaluation device changes diagnosis content of the stopping behavior of the driver of the own vehicle based on the presence or absence of intersecting traffic, the presence or absence of a preceding vehicle, and the traveling direction of the own vehicle.

### SUMMARY

At an intersection with a stop sign, the driver is required to confirm safety of traffic conditions before entering the intersection. However, it is not always possible to accurately judge whether the driver has entered the intersection upon having confirmed safety of traffic conditions, simply by judging whether the vehicle made a stop at an intersection with a stop sign.

It is conceivable to deal with this situation by installing a camera in the vehicle cabin for shooting images of the face of the driver, and judging whether the driver is confirming the safety of traffic conditions at an intersection with a stop sign, based on the images of the face of the driver. However, in order to make such judgment, a camera that shoots images of the face of the driver needs to be installed in the vehicle cabin.

An object of the present disclosure is to appropriately evaluate driving behavior of the driver at an intersection with a stop sign, even when no camera for shooting images of the face of the driver is installed in the vehicle cabin.

One aspect of the present disclosure is a driving evaluation system including an acquiring unit that acquires vehicle speed information indicating a vehicle speed of a vehicle and position information indicating a position of the vehicle, a determining unit that determines whether the vehicle is approaching an intersection with a stop sign, based on the position information, and an evaluation unit that, when the determining unit determines that the vehicle is approaching the intersection with the stop sign, evaluates driving behavior of a driver of the vehicle, based on a duration of time over which the vehicle is stopped at the intersection with the stop sign, or a speed at which the vehicle travels through the intersection with the stop sign.

According to the present disclosure, driving behavior of a driver at an intersection with a stop sign can be appropriately evaluated, even when no camera for shooting images of the face of the driver is installed in a vehicle cabin.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an overall configuration of a driving evaluation system according to an embodiment;

FIG. 2 is a block diagram illustrating a configuration of a vehicle related to evaluation of driving behavior;

FIG. 3 is a block diagram illustrating a configuration of an evaluation device;

FIG. 4 is a flowchart illustrating a flow of processing performed by the evaluation device;

FIG. 5A is a diagram showing a user interface for displaying an assessment;

FIG. 5B is a diagram illustrating a user interface for displaying an assessment;

FIG. 6A is a diagram showing a user interface which displays a test result; and

FIG. 6B is a diagram illustrating a user interface for displaying an assessment.

### DETAILED DESCRIPTION OF EMBODIMENTS

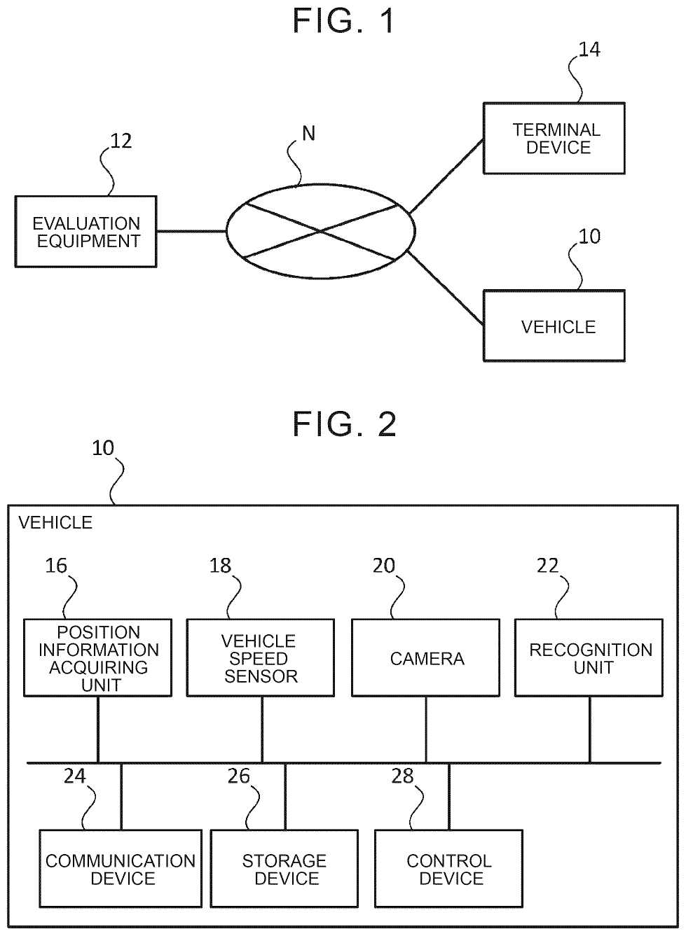

An overall system according to an embodiment will be described with reference to FIG. 1. FIG. 1 is a block diagram illustrating an overall configuration of a driving evaluation system according to an embodiment.

The overall system includes one or more vehicles 10, an evaluation device 12, and one or more terminal devices 14. The vehicle 10, the evaluation device 12, and the terminal device 14 have a function of communicating with each other via a communication path N such as the Internet.

The vehicle 10 transmits various kinds of information acquired by the vehicle 10 to the evaluation device 12 via the communication path N. For example, vehicle speed information indicating the vehicle speed of the vehicle 10, position information indicating the position of the vehicle 10, and the like are transmitted from the vehicle 10 to the evaluation device 12.

The evaluation device 12 evaluates the driving behavior of the driver of the vehicle 10 at the intersection with the stop sign based on various kinds of information (for example, vehicle speed information and position information) transmitted from the vehicle 10.

An intersection with a stop sign is an intersection at which the vehicle must pause immediately before the intersection. For example, when the pause sign is provided immediately before the intersection, the position immediately before the intersection or the position immediately before the stop line is the pause position, and the vehicle needs to pause at the pause position. A representative example of the pause sign is a road sign indicating the character string “stopped”. An intersection where a road surface indication indicating a pause (for example, a road surface indication indicating a character string “stopped”) is formed also corresponds to an example of an intersection with a stop sign.

The evaluation device 12 transmits the evaluation result information indicating the evaluation result of the driving behavior to the terminal device 14 via the communication path N. For example, the evaluation result indicated by the evaluation result information is displayed on the display of the terminal device 14 or is output as sound from the speaker of the terminal device 14.

The evaluation device 12 may transmit the evaluation result information to the vehicle 10 via the communication path N. In this case, the evaluation result is displayed on a display provided in the vehicle 10 or is output as sound from a speaker provided in the vehicle 10.

When the plurality of vehicles 10 are included in the overall system, the evaluation device 12 evaluates the driving behavior of the driver for each vehicle 10, and transmits the evaluation result information to the terminal device 14 corresponding to each vehicle 10 or transmits the evaluation result information to each vehicle 10.

The terminal device 14 is a personal computer (hereinafter referred to as “PC”), a tablet PC, a smart phone, a mobile phone, or the like. For example, the terminal device 14 is a device owned by a driver of the vehicle 10. The terminal device 14 may be a device mounted on the vehicle 10.

Hereinafter, with reference to FIG. 2, the configuration of the vehicle 10 and related to the evaluation of the driving behavior will be described. FIG. 2 is a block diagram illustrating a configuration of the vehicle 10 related to evaluation of driving behavior.

The vehicle 10 includes a position information acquiring unit 16, a vehicle speed sensor 18, a camera 20, a recognition unit 22, a communication device 24, a storage device 26, and a control device 28.

The position information acquiring unit 16 acquires position information indicating the position of the vehicle 10. For example, the position information acquiring unit 16 acquires the position information of the vehicles 10 by using a global positioning system (GPS). The position information acquiring unit 16 acquires position information at predetermined reference time intervals. Information indicating the time at which the position information is acquired is associated with the position information.

The vehicle speed sensor 18 measures the speed of the vehicle 10 and outputs speed information indicating the speed. The vehicle speed sensor 18 measures the speed at predetermined reference time intervals and outputs speed information. Information indicating the time at which the speed is measured is associated with the speed information.

The camera 20 photographs the front of the vehicle 10 to generate an image (for example, a moving image or a still image) representing the front of the vehicle 10. Information indicating the shooting time is associated with the image. Furthermore, the camera 20 may photograph the right side, the left side, and the rear of the vehicle 10.

The recognition unit 22 recognizes the pause sign from the image representing the front side by executing the recognition process on the image representing the front side of the vehicle 10 generated by the camera 20, and outputs the recognition result information indicating the recognition result. The recognition result information is information indicating whether or not a pause sign is recognized from an image representing the front of the vehicle 10. That is, the recognition unit 22 determines whether or not a pause indicator is represented in an image representing the front, and outputs recognition result 20 information indicating the determination result. The recognition unit 22 performs recognition processing at predetermined reference time intervals, thereby determining whether or not a pause sign is represented in an image representing a forward direction at each reference time, and outputs recognition result information. Information indicating the time at which the recognition process is executed is associated with the recognition result 25 information.

For example, the recognition unit 22 recognizes a pause sign from an image by using a pattern recognition technique or a recognition technique based on machine learning. The recognition unit 22 may recognize a pause indicator from images by using advanced driver assistance systems (ADAS).

The recognition unit 22 may recognize the road surface indication indicating the pause from the image representing the front. In this case, the recognition result information is information indicating whether or not the pause road surface indication is recognized from the image representing the front of the vehicle 10.

Note that the processing by the recognition unit 22 may be executed by the evaluation device 12. In this case, the image generated by the camera 20 is transmitted from the vehicle 10 to the evaluation device 12 via the communication path N. The evaluation device 12 analyzes the image to recognize a pause sign or a road surface sign indicating pause from the image.

The communication device 24 is a communication interface, and has a function of transmitting information to another device and a function of receiving information from another device. The communication device 24 associates the position information acquired by the position information acquiring unit 16, the speed information output from the vehicle speed sensor 18, the recognition result information indicating the result of the recognition by the recognition unit 22, and the identification information for identifying the vehicle 10 with each other. Then, the result of the association is transmitted to the evaluation device 12 via the communication path N. For example, each time the information is acquired, the communication device 24 transmits the information to the evaluation device 12. Specifically, the communication device 24 transmits these pieces of information to the evaluation device 12 at predetermined reference time intervals. The communication device 24 may transmit the image generated by the camera 20 to the evaluation device 12.

The storage device 26 is a device constituting one or a plurality of storage areas for storing information. For example, the storage device 26 may be a hard disk drive (HDD), a solid state drive (SSD), various memories (e.g., RAM, DRAM, NVRAM, ROM, etc.), or a combination thereof. The position information, the vehicle speed information, the image generated by the camera 20, the recognition result information, and the like are stored in the storage device 26.

The control device 28 controls operations of the position information acquiring unit 16, the vehicle speed sensor 18, the camera 20, the recognition unit 22, and the communication device 24. The function of the control device 28 may be realized by an electronic control unit (ECU).

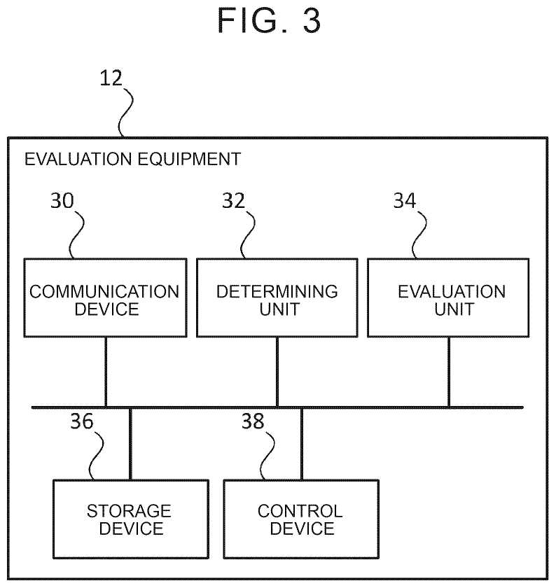

The configuration of the evaluation device 12 will be described with reference to FIG. 3. FIG. 3 is a block diagram illustrating a configuration of the evaluation device 12.

The evaluation device 12 includes a communication device 30, a determining unit 32, an evaluation unit 34, a storage device 36, and a control device 38.

The communication device 30 is a communication interface and has a function of transmitting information to another device and a function of receiving information from another device. When the position information, the speed information, the recognition result information, and the identification information are transmitted from the vehicle 10 to the evaluation device 12, the communication device 30 receives these pieces of information. When the image generated by the camera 20 is transmitted from the vehicle 10 to the evaluation device 12, the communication device 30 receives the image. The communication device 30 corresponds to an example of an acquiring unit.

The determining unit 32 determines whether or not the vehicle 10 is approaching the intersection with the stop sign based on the recognition result information.

When the recognition result information indicates that the pause sign or the pause road surface sign is recognized from the image representing the front of the vehicle 10, the determining unit 32 determines that the vehicle 10 is approaching the intersection with the stop sign. That is, when the pause sign or the pause road surface sign is represented in the image representing the front of the vehicle 10, the determining unit 32 determines that the vehicle 10 is approaching the intersection with the stop sign.

When the recognition result information does not indicate that the pause sign or the pause road surface sign is recognized from the image representing the front of the vehicle 10, the determining unit 32 determines that the vehicle 10 is not approaching the intersection with the stop sign. That is, when the pause sign and the pause road surface sign are not represented in the image representing the front of the vehicle 10, the determining unit 32 determines that the vehicle 10 is not approaching the intersection with the stop sign.

The determining unit 32 may determine whether or not the vehicle 10 is approaching the intersection with the stop sign by using a database storing information indicating each pause position on the roadway. Specifically, the determining unit 32 determines whether or not the vehicle 10 is approaching the intersection with the stop sign by comparing the information indicating each pause position stored in the database with the position information of the vehicle 10. Further, the determining unit 32 determines whether or not the vehicle 10 is present in the intersection with the stop sign by comparing the information indicating each pause position stored in the database with the position information of the vehicle 10.

The evaluation unit 34 evaluates the driving behavior of the driver of the vehicle 10. For example, when the determining unit 32 determines that the vehicle 10 is approaching the intersection with the stop sign, the evaluation unit 34 evaluates the driving behavior of the driver at the intersection with the stop sign.

The driving evaluation items include the length of the time (hereinafter referred to as “stop time”) during which the vehicle 10 stops at the intersection with the stop sign. The driving evaluation item includes a speed at which the vehicle 10 passes through the intersection with the stop sign (hereinafter referred to as “passing speed”). The driving evaluation items include the time required for the vehicle 10 to pass through the intersection with the stop sign (hereinafter referred to as “passing time”). The driving evaluation items include the number of intersections with stop signs in the traveling route. The evaluation unit 34 evaluates the driving behavior of the driver based on one or a plurality of driving evaluation items. The method of evaluation based on each operation evaluation item will be described later.

The communication device 30 transmits the evaluation result information indicating the evaluation result by the evaluation unit 34 to the terminal device 14 via the communication path N. The evaluation result is displayed on the display of the terminal device 14 or is output as sound from a speaker of the terminal device 14.

The communication device 30 may transmit the evaluation result information to the vehicle 10 via the communication path N. In this case, the evaluation result is displayed on a display provided in the vehicle 10 or is output as sound from a speaker provided in the vehicle 10.

The storage device 36 is a device constituting one or a plurality of storage areas for storing information. For example, the storage device 36 may be a HDD, SSD, various memories (e.g., RAM, DRAM, NVRAM, ROM, etc.), or a combination thereof. Information (for example, position information, vehicle speed information, an image generated by the camera 20, recognition result information, and the like) transmitted from the vehicle 10 to the evaluation device 12 is stored in the storage device 36.

The control device 38 controls operations of the communication device 30, the determining unit 32, and the evaluation unit 34.

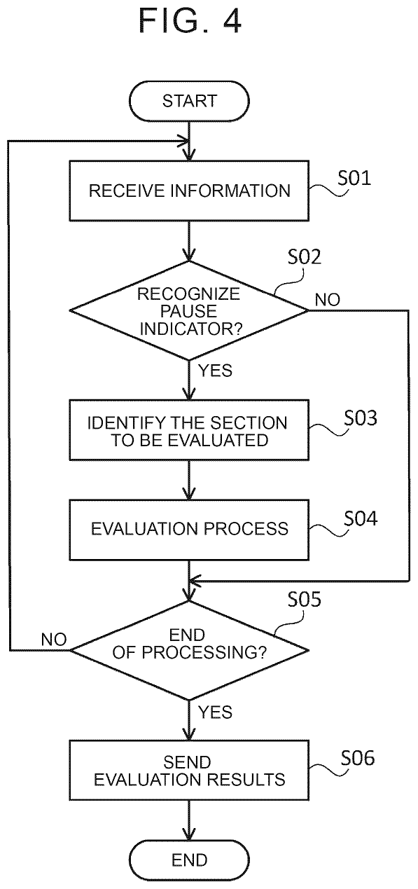

Hereinafter, a flow of processing by the evaluation device 12 will be described with reference to FIG. 4. FIG. 4 is a flowchart illustrating a flow of processing performed by the evaluation device 12.

The evaluation device 12 evaluates the driving behavior of the driver with respect to all or a part of the traveling route of the vehicle 10. For example, the traveling route is a section from a position where the driver has started driving the vehicle 10 to a position where the driver has finished driving the vehicle 10.

The communication device 24 of the vehicle 10 transmits the position information of the vehicle 10, the speed information of the vehicle 10, the recognition result information, and the identification information to the evaluation device 12 via the communication path N. The communication device 30 of the evaluation device 12 receives the position information of the vehicle 10, the velocity information of the vehicle 10, the recognition-result information, and the identification information from the vehicle 10 (S01). For example, the communication device 24 of the vehicle 10 transmits these pieces of information to the evaluation device 12 at predetermined reference time intervals, and the communication device 30 of the evaluation device 12 receives these pieces of information each time it is transmitted.

The determining unit 32 determines whether or not a pause indicator is recognized by the recognition unit 22 based on the recognition result information (S02). That is, the determining unit 32 determines whether or not the vehicle 10 is approaching the intersection with the stop sign based on the recognition result information.

When the pause indicator is recognized by the recognition unit 22 (S02, Yes), the evaluation unit 34 identifies the evaluation target section (S03).

The evaluation target section is a section from the evaluation start position to the evaluation end position. The evaluation start position is a position of the vehicle 10 when the pause sign is recognized. The evaluation end position is a position at which the vehicle 10 travels a predetermined distance after passing through the pause sign. The evaluation target section corresponds to a section of the intersection with the stop sign.

The evaluation unit 34 evaluates the driving behavior of the driver in the evaluation target section (that is, the intersection with the stop sign) on the basis of the position information, the speed information, and the recognition-result information acquired in the evaluation target section (S04).

When the process is finished (S05, Yes), the communication device 30 transmits evaluation result information indicating the evaluation result by the evaluation unit 34 to the terminal device 14 (S06). For example, when the traveling of the vehicle 10 is completed, the process ends. The evaluation result is displayed on the display of the terminal device 14 or is output as sound from a speaker of the terminal device 14.

When the process is not completed (S05, No), the process proceeds to S01, and the processes after S01 are executed.

If the pause indicator is not recognized in S02 (S02, No), the process proceeds to S05.

In a case where the average speed of the vehicle 10 in the evaluation target section is less than the threshold value and the front vehicle with respect to the vehicle 10 is recognized, it is estimated that a traffic jam has occurred. In this case, the evaluation unit 34 may not evaluate the driving behavior in the evaluation target section.

In addition, when the interval between the time in which a certain evaluation target section is specified and the time in which the next evaluation target section is specified is less than the threshold value, there is a possibility that the evaluation target section and the next evaluation target section are erroneously detected. In this case, the evaluation unit 34 may not evaluate the driving behavior in the evaluation target section and the next evaluation target section.

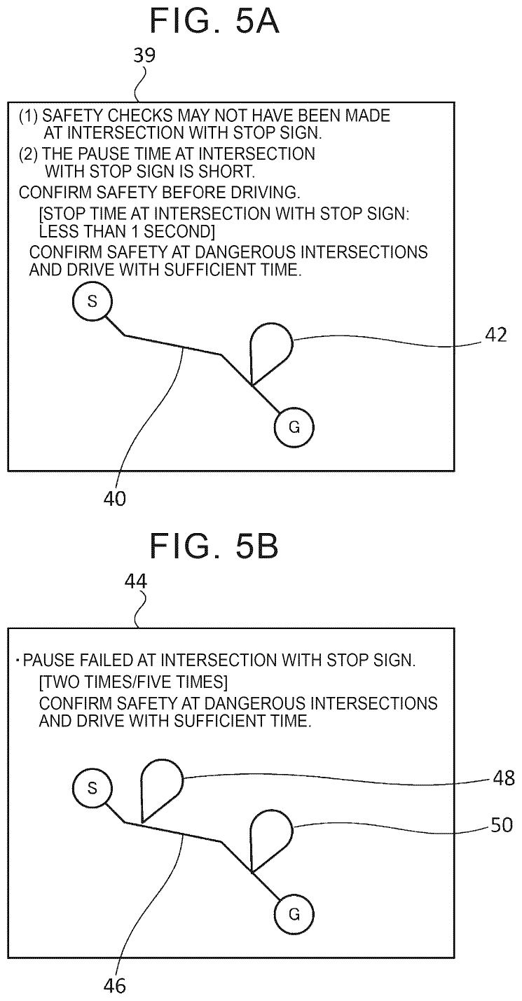

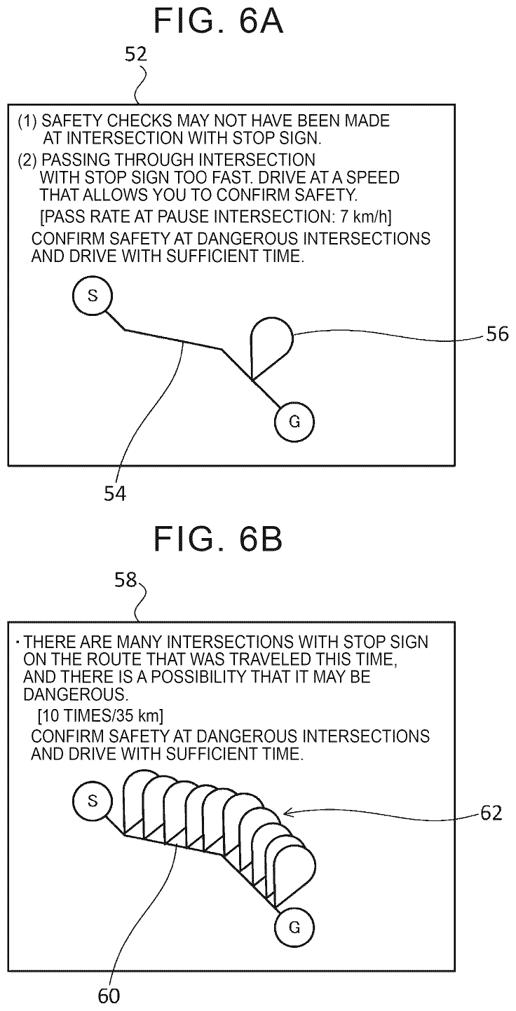

Hereinafter, with reference to FIG. 5A, FIG. 5B, FIG. 6A and FIG. 6B, embodiments will be described. FIG. 5A, FIG. 5B, FIG. 6A, and FIG. 6B are diagrams illustrating a user interface representing an assessment.

### First Embodiment

In the first embodiment, the evaluation unit 34 evaluates the exercise behavior of the driver of the vehicle 10 based on the length of the time (stop time) during which the vehicle 10 stops at the intersection with the stop sign. The evaluation unit 34 determines whether or not the vehicle 10 is stopped at the intersection with the stop sign based on the vehicle speed information of the vehicle 10.

It is presumed that the longer the stop time, the more carefully the driver confirms the surrounding safety and the like. Therefore, the evaluation unit 34 evaluates that the exercise behavior of the driver is safer as the stop time is longer.

The evaluation unit 34 may rank the safety level of the driving behavior in stages according to the length of the stopping time. For example, the rank is a relative rank between an average of the stopping times of other drivers (e.g., a statistically processed average).

In a case where a plurality of intersections with stop signs are recognized in the traveling route, the evaluation unit 34 may evaluate the driving behavior on the basis of the stop time for each intersection with a stop sign. When a plurality of intersections with stop signs are recognized in the traveling route, an average value of the stopping times of the plurality of intersections with stop signs may be calculated, and the driving behavior may be evaluated based on the average value.

The evaluation result information indicating the evaluation result based on the stop time is transmitted to the terminal device 14, and the evaluation result is displayed on the display of the terminal device 14. The representation is shown in FIG. 5A. The screen 39 is a user interface representing the evaluation result, and is displayed on the display of the terminal device 14.

The route image 40 is displayed on the screen 39. The route image 40 is an image representing a travel route of the vehicle 10. A map (not shown) is displayed on the screen 39, and the route image 40 is displayed on the map. The traveling route is specified based on the position information of the vehicle 10, and the information indicating the traveling route is included in the evaluation result information and transmitted from the evaluation device 12 to the terminal device 14.

In the embodiment shown in FIG. 5A, the stopping time at the intersection with the stop sign is less than the threshold (e.g., less than 1 second), and the information indicating this is displayed on the screen 39. For example, “Safety confirmation may not be possible at the intersection with the stop sign.” A message is displayed on the screen 39.

A mark 42 is displayed on the route image 40. The mark 42 is an image representing an intersection with a stop sign where the pause time is less than the threshold value, and is displayed at a position where the intersection with the stop sign is recognized on the route image 40.

By referring to the information displayed on the screen 39, the driver can confirm the length of the stop time at the intersection with the stop sign and confirm the safety of the driver's driving behavior. For example, the driver can confirm the intersection with the stop sign at which the stop time was short.

FIG. 5B shows another assessment. When it is determined that the vehicle is not paused at the intersection with the stop sign, a screen 44 shown in FIG. 5B is displayed on the display of the terminal device 14.

A route image 46 representing the travel route is displayed on the screen 44. The marks 48 and 50 are images representing an intersection with a stop sign at which it is determined that the vehicle 10 is not paused, and are displayed on the route image 46.

### Second Embodiment

In the second embodiment, the evaluation unit 34 evaluates the driving behavior of the driver of the vehicle 10 based on the speed (passing speed) at which the vehicle 10 passes through the intersection with the stop sign.

When the passing speed is low, it is assumed that the vehicle 10 is passing through the intersection with the stop sign at a speed that allows the driver to confirm the safety of the surroundings. Therefore, the evaluation unit 34 evaluates that the driver's driving behavior is safer as the passing speed is lower.

The evaluation unit 34 may rank the safety level of the driving behavior in stages according to the passing speed. When a plurality of intersections with stop signs are recognized, the evaluation unit 34 may evaluate the driving behavior based on the passing speed for each intersection with a stop sign, or may calculate an average value of the passing speeds of the plurality of intersections with stop signs and evaluate the driving behavior based on the average value.

The evaluation result information indicating the evaluation result based on the passing speed is transmitted to the terminal device 14, and the evaluation result is displayed on the display of the terminal device 14. The representation is shown in FIG. 6A. The screen 52 is a user interface representing the evaluation result, and is displayed on the display of the terminal device 14.

A route image 54 representing the travel route is displayed on the screen 52. In the exemplary embodiment shown in FIG. 6A, the passing velocity at the intersection with the stop sign is 7 km/h greater than or equal to a threshold. Information indicating this is displayed on the screen 52. For example, “Passing through a stop intersection too fast. Drive at a speed that allows you to confirm safety.” A message is displayed on the screen 52.

A mark 56 is displayed on the route image 54. The mark 56 is an image representing an intersection with a stop sign at which the passing speed is equal to or higher than the threshold value, and is displayed at a position where the intersection with the stop sign is recognized on the route image 54.

By referring to the information displayed on the screen 52, the driver can confirm the passing speed at the intersection with the stop sign and confirm the safety of the driver's own driving behavior. For example, the driver can confirm an intersection with a stop sign at which the passing speed was high.

### Third Embodiment

In the third embodiment, the evaluation unit 34 evaluates the driving behavior of the driver of the vehicle 10 based on the time (passing time) required for the vehicle 10 to pass through the intersection with the stop sign.

If the transit time is long, it is assumed that the vehicle 10 is passing through the intersection with the stop sign at a speed that allows the driver to confirm the safety of the surroundings. Therefore, the evaluation unit 34 evaluates that the driver's driving behavior is safer as the passage time is longer.

The evaluation unit 34 may rank the safety level of the driving behavior in a stepwise manner according to the transit time. When a plurality of intersections with stop signs are recognized, the evaluation unit 34 may evaluate the driving behavior based on the passing time for each intersection with a stop sign, or may calculate an average value of the passing times of the plurality of intersections with stop signs and evaluate the driving behavior based on the average value.

In the third embodiment, as in the first and second embodiments, the evaluation result based on the transit time is displayed on the display of the terminal device 14. For example, a mark indicating an intersection with a stop sign in which the passing time is less than the threshold is displayed on a route image representing the traveling route. In this way, the driver can confirm the intersection with the stop sign at which the transit time was short.

### Fourth Embodiment

In the fourth embodiment, the evaluation unit 34 evaluates the driving behavior of the driver of the vehicle 10 based on the number of intersections with stop signs in the traveling route.

It is presumed that a traveling route having a smaller number of paused intersections is a traveling route having a lower necessity of pausing and confirming safety. Therefore, the evaluation unit 34 evaluates that the driver's driving behavior is safer as the number of intersections with stop signs in the traveling route is smaller.

The evaluation result information indicating the evaluation result based on the number of paused intersections is transmitted to the terminal device 14, and the evaluation result is displayed on the display of the terminal device 14. The representation is shown in FIG. 6B. The screen 58 is a user interface representing the evaluation result, and is displayed on the display of the terminal device 14.

A route image 60 representing the travel route is displayed on the screen 58. In the embodiment shown in FIG. 6B, the vehicles 10 pass through ten intersections with stop signs during the travel route. The mark 62 is an image group representing ten intersections with stop signs, and is displayed at a position where each intersection with a stop sign is recognized on the route image 60.

By referring to the information displayed on the screen 58, the driver can confirm the number of intersections with stop signs existing in the traveling route.

Note that the evaluation unit 34 may calculate a recommended traveling route that is a traveling route from the start position to the end position of the driving and has a smaller number of intersections with stop signs. The information indicating the recommended travel route is transmitted from the evaluation device 12 to the terminal device 14 and displayed on the display of the terminal device 14. In this way, the driver can confirm a traveling route having a smaller number of intersections with stop signs.

As described above, according to the present embodiment, the driving behavior of the driver is evaluated based on the stop time at the intersection with the stop sign, the passing speed at the intersection with the stop sign, the passing time at the intersection with the stop sign, or the number of intersections with stop signs at the traveling route. Accordingly, it is possible to appropriately evaluate the driving behavior without providing a camera for photographing the driver's face in the vehicle cabin in order to determine whether or not the driver confirms the safety of the surroundings based on the image of the driver's face.

Note that the evaluation device 12 may be executed by combining a plurality of embodiments among the first to fourth embodiments. In this case, the evaluation device 12 may calculate the average of the evaluation results of the respective embodiments as the final evaluation, or may calculate the final evaluation by applying the weighting process according to the embodiments to the evaluation results.

The function of the evaluation device 12 may be realized by a single device or may be realized by a plurality of devices. In addition, some functions of the evaluation device 12 may be realized by the vehicle 10. Similarly, some functions of the vehicle 10 may be implemented by the evaluation device 12. A system for evaluating driving behavior may be constructed by the vehicle 10 and the evaluation device 12.

The position information acquiring unit 16, the recognition unit 22, and the control device 28 can be realized by using hardware resources such as a processor and an electronic circuit, for example, and a device such as a memory may be used as necessary in the implementation. The position information acquiring unit 16, the recognition unit 22, and the control device 28 may be implemented by, for example, a computer. That is, all or a part of the position information acquiring unit 16, the recognition unit 22, and the control device 28 may be realized by cooperation of a hardware resource such as a central processing unit (CPU) or a memory included in the computer and software (program) that defines an operation of CPU or the like. The program is stored in a storage device of the vehicle 10 via a recording medium such as a CD or a DVD, or via a communication path such as a network. As another example, the position information acquiring unit 16, the recognition unit 22, and the control device 28 may be realized by a digital signal processor (DSP), an application specific integrated circuit (ASIC), or a field programmable gate array (FPGA). Of course, a graphics processing unit (GPU) and the like may be used.

Similarly, the determining unit 32, the evaluation unit 34, and the control device 38 can be realized by using hardware resources such as a processor and an electronic circuit, for example, and devices such as a memory may be used as necessary in the implementation. The determining unit 32, the evaluation unit 34, and the control device 38 may be implemented by, for example, a computer. That is, all or a part of the determining unit 32, the evaluation unit 34, and the control device 38 may be realized by cooperation of hardware resources such as CPU and memories included in the computer and software (programs) that define operations of CPU and the like. The program is stored in a storage device of the evaluation device 12 via a recording medium such as a CD or a DVD or via a communication path such as a network. Alternatively, the determining unit 32, the evaluation unit 34, and the control device 38 may be implemented by a DSP, ASIC, a FPGA, or the like. Of course, a GPU or the like may be used.

What is claimed is:

1. A driving evaluation system comprising:
an acquiring unit that acquires vehicle speed information indicating a vehicle speed of a vehicle and position information indicating a position of the vehicle;
a determining unit that determines whether the vehicle is approaching an intersection with a stop sign, based on the position information; and
an evaluation unit that, when the determining unit determines that the vehicle is approaching the intersection with the stop sign, evaluates driving behavior of a driver of the vehicle, based on a duration of time over which the vehicle is stopped at the intersection with the stop sign, or a speed at which the vehicle travels through the intersection with the stop sign.

2. The driving evaluation system according to claim 1, wherein the longer the time over which the vehicle is stopped at the intersection with the stop sign is, or the lower the speed at which the vehicle travels through the intersection with the stop sign is, the safer the evaluation unit evaluates the driving behavior to be.
